(19) United States
(12) Patent Application Publication
(10) Pub. No.: US 2007/0198660 A1
(43) Pub. Date: Aug. 23, 2007

(54) Advertising Supported Recorded and Downloaded Music System

(76) Inventor: Marc S. Cohen, Lincolnwood, IL (US)

Correspondence Address: Marc Cohen, 4850 West Morse Avenue, Lincolnwood, IL, 60712, US

(21) Appl. No.: 11/676,662

(22) Filed: Feb. 20, 2007

Related U.S. Application Data
(60) Provisional application No. 60/775,214, filed on Feb. 21, 2006.

(51) Int. Cl. G06F 15/16

(52) U.S. Cl. 709/219

(57) ABSTRACT

Music tracks are made available to users at no cost because advertisements are automatically intermixed between the tracks. Free music tracks, ads and machine readable instructions for playing the ads are downloaded from a central computing system to digital media players. Portable digital media players are well suited for practice of the invention. After a track is played the digital media player checks the ad-play instructions to determine if an ad is to be played. If so, the appropriate ad is played, if not, the next track chosen by the user is played. Logs of ad play and track play are maintained on the digital media player and uploaded to the central computing system. Wireless communication between the digital media player and the central computing system are well suited for practice of this invention. The data from the logs is aggregated by the central computing system and used to charge advertisers and compensate copyright holders in the music tracks.

### PROVISIONAL PATENT APPLICATION

This patent application claims benefit of the filing date of the associated provisional Patent Application No. 60/775,214 filed on Feb. 21, 2006.

### FIELD OF THE INVENTION

This invention concerns an advertising method for use with audio or video musical content that is played from memory (recorded onto a media or downloaded) on a digital media player. Other fields of the invention are the field of messaging and the field of digital media players.

### BACKGROUND OF THE INVENTION

All around the world, and especially in the United States, the recorded music industry has been suffering. CD (compact disc) sales have dropped and illegal copying and sharing of recorded music has risen. The International Federation of the Phonographic Industry estimates that in January 2006, 885 million illegal music files were available for sharing on the Internet. The recorded music industry has tried many different tactics for combating illegal file sharing including the initiation of thousands of lawsuits against companies and individuals. One potentially effective method to fight illegal file sharing is to make legal recorded or downloaded music available at a lower price or free. Free, or cheaper, recorded and downloaded music may also help to expand the size of the recorded music market and increase recorded music industry revenues.

In other media, including radio and television, advertising support permits free or lower price, content distribution. Providing advertising support to lower, or eliminate, the cost to the end user has not been tried for recorded music. The art in the field does not describe an approach that would support widespread adoption of advertising supported recorded music. This invention fills the gap in the art.

### SUMMARY OF THE INVENTION

Digital media players (DMPs) are registered with a Central Computing System (CCS). A preferred CCS is composed of computers, servers, software, and Internet sites. In the preferred embodiment, the digital media player is a portable device.

The CCS receives advertisements (ads) from an ad source. The CCS determines when, and to which registered DMPs, the ad should be distributed. The ad file is then downloaded to DMPs and stored in memory accessible by the digital media player. The CCS also prepares an ad-play instruction file that controls when the DMP plays an ad. The ad-play instruction file is periodically downloaded to DMPs and is not necessarily associated with a specific ad.

A user acquires a track from any source. A track may be an audio only music file, e.g. a song, or an audio and video music file, often referred to as a music video. The track is stored in memory on the DMP and the user plays the track on the DMP. The DMP reads any metadata appended to the track file in order to identify the track. If identifying metadata is not present, the DMP samples the content of the track for uploading to the CCS where it can be identified. The DMP records and stores the information that the particular track has been played. This information is stored in a log file, such as a database, in memory accessible by the DMP.

Before or after each track is played, the DMP checks its ad-play instructions to determine if an ad should be played. If no ad is to be played, the DMP plays the next track. If an ad is to be played, an ad is retrieved from memory in accord with the ad-play instructions, played and output on the DMP in a form understandable by a user. The DMP records and stores the information in a log file that the particular ad has been played.

DMPs periodically upload the track and ad data that have been saved in accessible memory. The CCS stores and analyzes the uploaded data. Rights holders in tracks are compensated per agreement according to the number of plays in a given period. Ad customers are charged per agreement according to plays in a given period.

### BRIEF DESCRIPTION OF THE DRAWINGS

Other features and advantages will become apparent upon reading the following detailed description in which:

FIG. 1 is a flowchart illustrating the major elements of the invention.

FIG. 2 illustrates the process of ad distribution.

FIG. 3 illustrates the ad and track play process that occurs on the digital media player.

FIG. 4 illustrates the track identification process.

FIG. 5 illustrates the process for aggregating track and ad play data; for compensating rights holders in the tracks and for charging advertisers.

### DETAILED DESCRIPTION OF THE PREFERRED EMBODIMENT

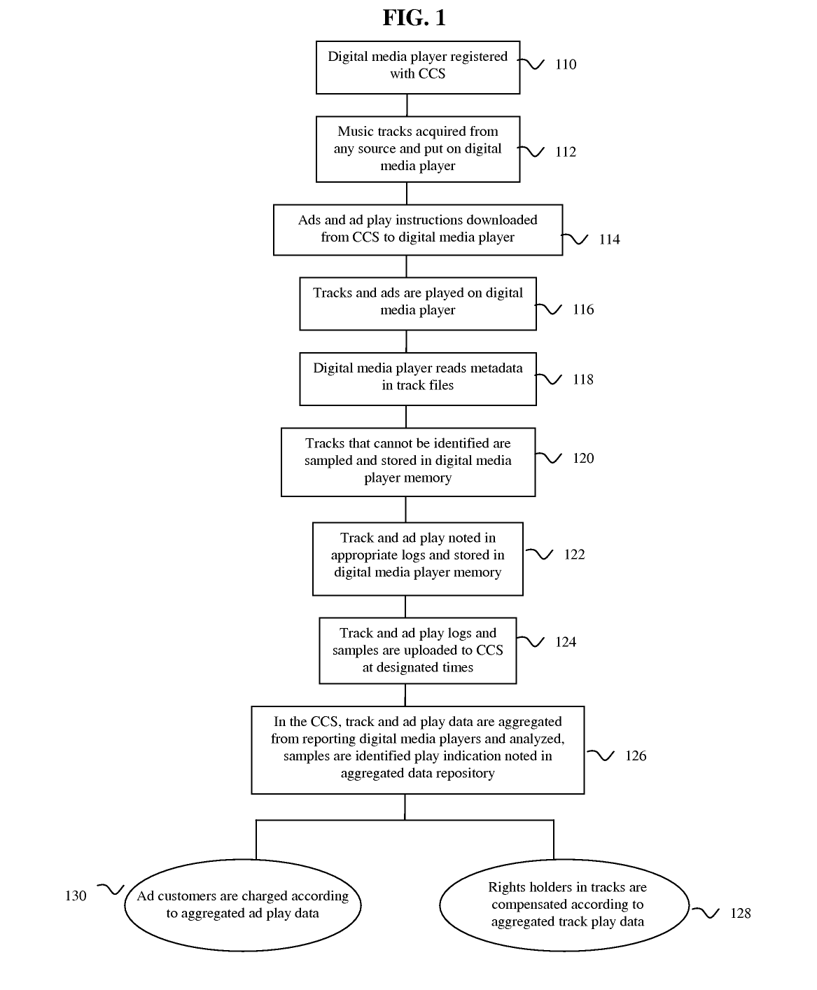

The invention describes a method for subsidizing the full or partial cost of a music track through advertising. Referring now to FIG. 1, digital media players (DMPs) are registered with the Central Computing System (CCS) 110. A DMP is any device that can play digitally formatted tracks from an on-board storage media. The DMP may be a portable media player like the Apple iPod. The DMP may be a software-based player on a personal computer or other computing device, such as Windows Media Player. The digital media player may be included on a cellular phone. The preferred device is a portable DMP. Users may register their own DMP. Alternatively, DMPs may be registered by a third-party such as, but not limited to; a device manufacturer, a cellular phone operator, a music provider or a music seller. It is preferred that DMPs are registered by a third-party and that the registration is activated by the user.

The user acquires tracks and loads them on a storage media in the DMP 112, so that the track can be played upon command established by the user. The track may already be on storage media that is placed into the DMP, e.g. a CD. The invention is designed to work with digitally formatted tracks obtained from any source including, but not limited to; CDs, Internet sites, ripping from a CD, DVD or other storage media, and peer-to-peer (P2P) or file-sharing networks; in any digital compression format e.g., MP3, MP4, AAC, WMA, WMV, Ogg Vorbis, etc. The user may or may not have the legal right to possess or play the track. The track may or may not be protected by a Digital Rights Management (DRM) scheme. In the preferred embodiment, tracks are provided legally by the CCS, through the Internet, at no cost to the user, with DRM and metadata in a digital file produced specifically to work with this advertising supported music system.

Ads and ad-play instructions are downloaded from the CCS to the DMP 114. The user begins a music listening session on a DMP in which tracks and ads are played 116. Tracks are played upon command of the user, while ads are played automatically according to the downloaded ad-play instructions.

The DMP reads the metadata appended to the track files played in order to identify the track and to determine if the track is a free track 118. Metadata is a structured data chunk containing descriptive data about the track file to which it is appended and commonly contains: artist name, track title, year released and genre. This information is sufficient to identify copyright holders in the track. A free track is one that is provided at no cost, or at a reduced price, to the user through the CCS. A free track is identified through a free track metadata indicator placed in the track file by the CCS. If the DMP cannot identify the track from the metadata, it takes and stores a full or partial sample of the content of the track so that the track can later be identified by the CCS 120. Track identification is necessary to properly compensate copyright holders in the track.

The DMP produces and stores logs of all ads and tracks played 122. Logs may be in the form of a database file. Track and ad-play logs and track samples, if any, are uploaded to the CCS 124. Uploading is a transfer of data from the DMP to the CCS. The uploading process is initiated by an instruction from the CCS to the DMP and preferably runs in a background application so that it can be accomplished without the user's knowledge.

The CCS aggregates and analyzes log data and track samples uploaded from reporting DMPs 126. Based on this aggregated data, copyright holders in tracks are compensated 128 and advertising customers are charged 130.

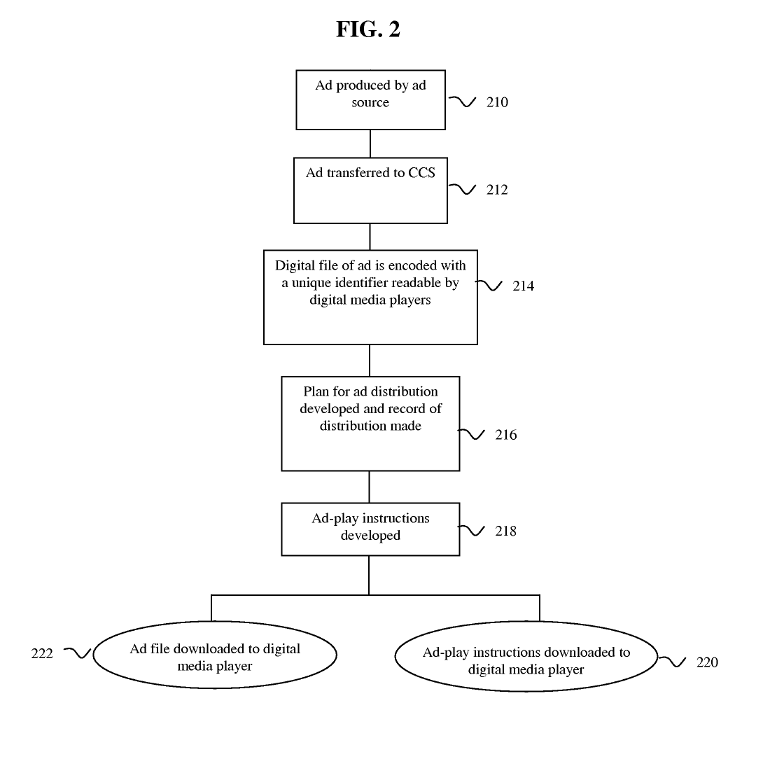

Referring now to FIG. 2, ads are produced by an ad source 210 and transferred to the CCS 212. The preferred method of ad transfer is electronic. The ads may be audio, audio and video, video only, text, graphical or any other format that can be reproduced and output by a DMP in a form that is understandable by the user. Because music is primarily an audio form, audio is the preferred ad format. It is also preferred that an audio ad is accompanied by an associated image that appears on the screen of the DMP while the audio ad is playing and for a period of time after the audio ad ends. The ad may be interactive. For example, a key press on the DMP while the ad is playing may open an Internet site linked to the ad. Alternatively, a key press may initiate the playback of additional information related to the ad that has been stored in memory on the DMP.

The CCS attaches identifying metadata to the ad file constituting, at least, a unique identifier 214. Utilizing programmed business rules and algorithms, the CCS software creates a plan for when, and to which registered DMPs, an ad should be distributed and stores a record of the plan 216. The CCS also prepares machine readable ad-play instructions that control when the DMP plays an ad and which ad is selected for play 218. Tracks and ads are intermixed on the DMP into an output that results from the combination of; the ads on the DMP, the ad-play instructions and the tracks a user chooses to play.

The ad-play instruction file is transferred, or downloaded, to a plurality of DMPs and stored in memory 220. The ad file is also downloaded to a plurality of DMPs and stored in memory 222. Downloads are initiated by the CCS and in a preferred embodiment occur in a background application without the knowledge of the user. The transfer of files and data between the digital media player and CCS may take place over any suitable communication channel. The communication channels may be wired or wireless. The wired communication channels may be, but are not limited to; cable, DSL, telephone, T-lines or power line. The wireless communication channels may be, but are not limited to; cellular, Bluetooth, DVB-H, MediaFlo, Wi-Fi, Wi-Max, digital radio, digital TV, and ultra wideband. The preferred communication channel for data transfer between the CCS and DMP is a wireless channel.

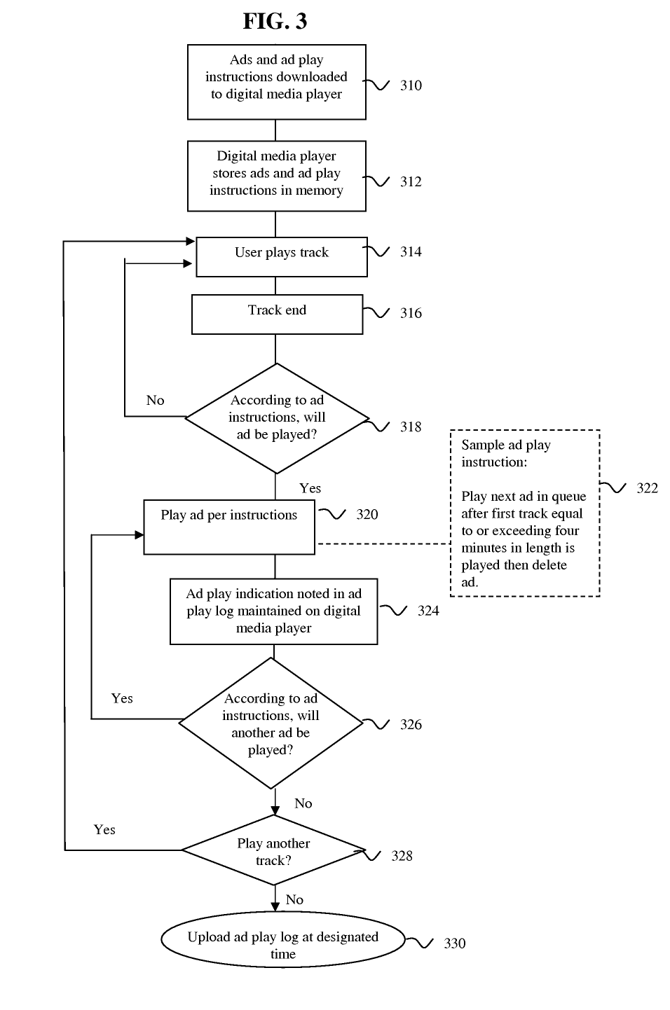

FIG. 3 depicts the preferred sequence for determining ad play. Ads and machine readable ad-play instructions are downloaded to the DMP 310. The DMP stores ads and ad-play instructions in appropriate electronic memory sites 312. The user commands the DMP to play a track 314. The track reaches its end 316 either by playing through, fast forwarding or skipping to another track.

At the end of a track the DMP checks the ad-play instructions it has received from the CCS to determine if an ad is to be played prior to the start of the next track 318. If the ad-play instructions dictate that no ad is to be played, the next track selected by the user is played 314. If the ad-play instructions dictate that an ad is to be played 320, the appropriate ad is retrieved from DMP memory and played according to the ad-play instructions 322. When an ad is played, the DMP makes an indication that the ad has played in the ad-play log maintained in DMP memory 324. At a minimum the DMP places an indication in the log that a track or ad started to play. It is preferred that the DMP places indications in the log of; time and date of play, whether the ad was completely played or what portion was played.

Following the playing of an ad, the DMP again checks its ad-play instructions to determine if another ad should be played 326. If the ad-play instructions dictate that another ad should be played 320, the appropriate ad is retrieved from DMP memory and played according to the ad-play instructions 322. If the ad-play instructions dictate that another ad should not be played, control of the DMP reverts to the user 328 and the next track selected by the user is played 314. If the user has not commanded the DMP to play another track, the DMP will enter a mode that enables it to upload the ad-play log at the appropriate time 330.

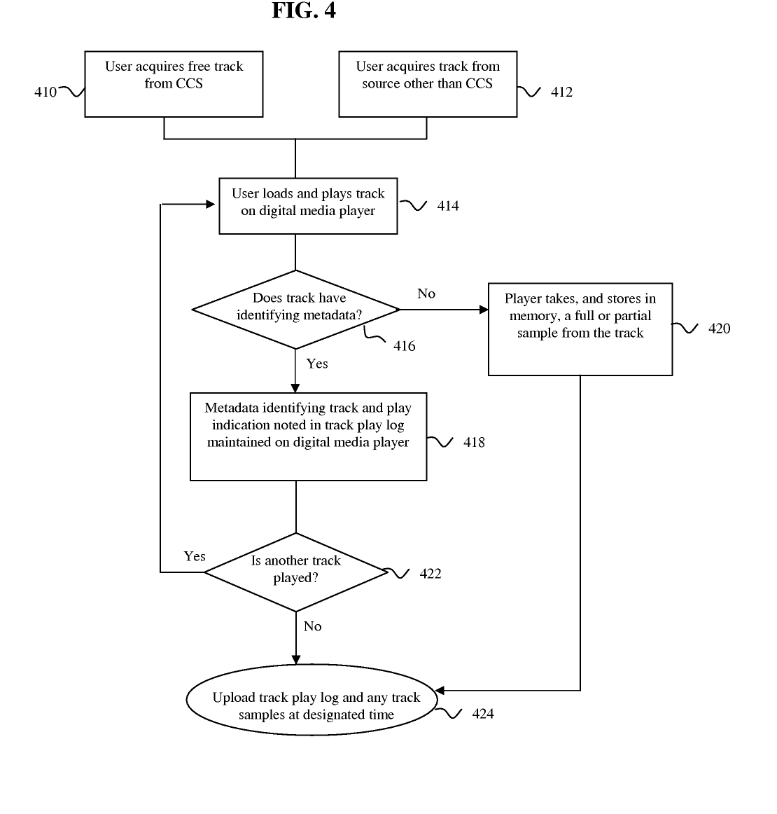

FIG. 4 depicts the preferred method for identifying tracks played on a DMP. Users may acquire free tracks from the CCS 410 or they may acquire tracks from any other source 412. Tracks acquired from any source will work with the invention. Acquired tracks are loaded and played on the DMP 414.

The DMP checks the track file for identifying metadata 416. The metadata may include the free track indicator, which is placed in the track file of a free track by the CCS prior to sending the track to the user. The DMP determines if a track is a free track by checking for the free track metadata indicator. The DMP reads all the metadata in a track file, including the free track metadata indicator if present. The DMP attempts to identify the artist, track title, album and other data necessary to confirm identity of the copyright holders in the track. The invention encompasses any track identification method that can be implemented on the DMP or CCS. The preferred method of track identification is the presence of ID3 metadata, or the equivalent, in the track file. ID3 is a very popular file data tagging format in active use by software and hardware developers around the world.

On free tracks provided through the CCS, in addition to the free track metadata indicator, metadata indicating artist, track title, album and other data necessary to confirm identity of the copyright holders in the track will be appended to the track file prior to downloading the track to the user. The identification of the track, the free track indicator if present, and a track play indication will be noted on the track play log maintained on the DMP 418.

Tracks that are not identified on the DMP through metadata will be sampled by the digital media player 420. The sample will be uploaded to the CCS for identification 424. Track samples on the CCS may be identified by any appropriate method. The preferred CCS track identification method is audio fingerprinting technology such as that developed by Philips Electronics. An audio fingerprint is a unique code that is generated from every second of audio. Comparing the audio fingerprint of a track sample to a known sample permits rapid and accurate identification from commercially available databases containing known audio fingerprint samples of millions of tracks.

The DMP repeats the track identification process each time a track is played 422. When the user has not commanded the DMP to play another track, the DMP will enter a mode that enables it to upload the ad-play log at the appropriate time 424.

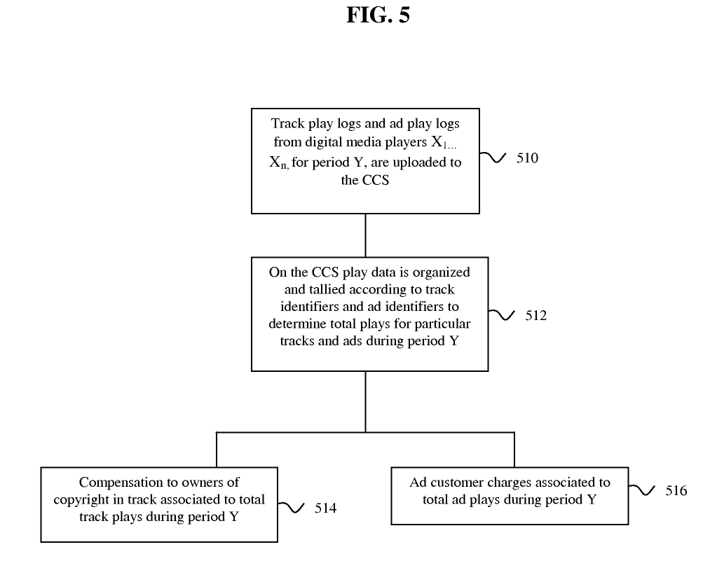

Referring now to FIG. 5, the preferred process for aggregating play data is illustrated. Track play logs and ad-play logs for a particular time period, and from a plurality of DMPs, are uploaded to the CCS 510. The CCS stores in a database, then analyzes, the uploaded data 512. At a minimum, the CCS aggregates data by track and ad identifiers. The CCS may calculate the total plays, across all DMPs, or any sub-group, for any ad or track, for any period. It is preferred that the CCS produces play reports for tracks and ads that can be viewed over the Internet.

Copyright holders in tracks are compensated based on the aggregate number of track plays in a given period 514. Compensation might be in the form of money or credit. For example, the grant of a certain number of advertising spots to a copyright owner at no charge. Ad customers are charged based on the aggregate number of ad plays in a given period 516.

### CONCLUSIONS

The invention described herein, for supplying ads and free tracks to a DMP, and for logging and reporting the same, will enable users to easily enjoy free music tracks, give advertisers an efficient new marketing channel, and provide copyright holders in music tracks a new source of revenue. By providing a free and legal alternative to illegally downloading music, the implementation of the invention could help to reduce music piracy. Furthermore, this advertising supported music system is the first technology that can facilitate a payment to copyright holders for illegally obtained tracks. Accordingly, the reader will see that this invention fills a gap in the prior art and provides numerous advantages to consumers, advertisers and copyright holders.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the description.

Various features of the invention are set forth in the appended claims.

What is claimed is:

1. An advertising supported music system comprising:
A digital media player;
a central computing system;
a first means for registering said digital media player with said central computing system;
advertisements that can be played on said digital media player in a user understandable output;
instructions that control when advertisements are played in relation to music tracks played on said digital media player;
a second means for transferring said advertisements and said instructions from said central computing system to said digital media player;
a log of advertisements played on said digital media player that is maintained on said digital media player;
a log of music tracks played on said digital media player that is maintained on said digital media player:
a third means for transferring said log of advertisements and said log of music tracks played on said digital media player to said central computing system;
a fourth means for compensating owners of rights in music tracks based on said log of music tracks played; and
a fifth means for charging advertisers based on said log of advertisements played;
whereby consumers, owners of copyrights in music and advertisers can benefit from advertising supported music tracks.

2. The transferring of the ads and instructions of claim 1, wherein the means for transferring ads and instructions are wireless.

3. The transferring of the advertisements played log and music tracks played log of claim 1, wherein the means for transferring the logs are wireless.

4. The advertisements of claim 1, wherein the advertisements are interactive.

5. The means for compensating owners of rights in music tracks of claim 1, wherein the means are in the form of advertising credits.

6. A method for compensating rights holders in music tracks played on a digital media player comprising:
determining, on the digital media player, music tracks that are not properly identified;
sampling, on the digital media player, a full or partial portion of the music track that is not properly identified;
transferring the sampled music track portion from the digital media player to a central computing system;
identifying the music track, based on the tagged portion, on the central computing system, and
compensating rights holders in the music track for playing of the music track after identification of the music track;
whereby rights holders in music tracks can be compensated for music tracks played on digital audio music players regardless of whether the music tracks included standard identification tags.

7. An advertising supported music method comprising:
registering a digital media player with a central computing system;
providing advertisements that can be played on said digital media player in a user understandable output;
transferring said advertisements from said central computing system to said digital media player;
providing instructions that control when advertisements are played in relation to music tracks played on said digital media player;
transferring said instructions from said central computing system to said digital media player;
maintaining on said digital media player a log of advertisements played on said digital media player;
transferring said log of advertisements played on said digital media player to said central computing system;
maintaining on said digital media player a log of music tracks played on said digital media player;
transferring said log of music tracks played on said digital media player to said central computing system;
compensating owners of rights in music tracks based on said log of music tracks played; and
charging advertisers based on said log of advertisements played;
whereby consumers, owners of rights in music and advertisers can benefit from advertising supported music tracks.

8. The transferring of the ads and instructions of claim 7, wherein the means for transferring ads and instructions are wireless.

9. The transferring of the advertisements played log and music tracks played log of claim 7, wherein the means for transferring the logs are wireless.

10. The advertisements of claim 7, wherein the advertisements are interactive.

11. The means for compensating owners of rights in music tracks of claim 7, wherein the means are in the form of advertising credits.
